(19) United States
(12) Patent Application Publication
(10) Pub. No.: US 2007/0186480 A1
(43) Pub. Date: Aug. 16, 2007

(54) AUTOMATIC DOOR CONTROL SYSTEM

(76) Inventor: Brian Freeman, Georgetown, KY (US)

Correspondence Address: BRIAN RENDELL FREEMAN, 109 PERCY PLACE, GEORGETOWN, KY, 40324, US

(21) Appl. No.: 11/685,320

(22) Filed: Mar. 13, 2007

Related U.S. Application Data
(63) Continuation-in-part of application No. 10/722,999, filed on Nov. 24, 2003, now Pat. No. 7,213,369.
(60) Provisional application No. 60/428,471, filed on Nov. 22, 2002.

(51) Int. Cl. E05F 11/00; G05B 19/00

(52) U.S. Cl. 49/358; 49/334; 340/5.84; 704/231; 340/5.52

(57) ABSTRACT

The present invention provides an automatic door control system that includes a door, a control module assembly, and a drive train assembly. The control module assembly is coupled to the door. The drive train assembly is coupled to the control module assembly, where the drive train assembly is configured to receive a signal from the control module assembly to easily move the door, where the drive train assembly exerts a force to move the door.

### CROSS-REFERENCE TO RELATED APPLICATIONS

This application is a continuation-in-part of U.S. application Ser. No. 10/722,999 filed Nov. 24, 2003, which, in turn, claims the benefit of U.S. provisional application Ser. No. 60/428,471 filed Nov. 22, 2002.

### TECHNICAL FIELD

The embodiments described herein relate to a door opening/closing apparatus, which facilitates the easy opening and closing of a door.

### BACKGROUND OF THE INVENTION

Generally, people use their hands to open and close doors. The typical doors that may be opened and closed are car doors, house doors, refrigerator doors, etc. These standard doors require a certain amount of physical strength to open and close them so some elderly and handicapped people may not be able to easily open and close them. In addition, if a person has a lot of groceries it is cumbersome for her to open the doors and hold the groceries at the same time.

There were several patents developed to address the problem of opening and closing the doors, such as U.S. Pat. Nos. 5,988,709 and 5,522,656. The inventions described in these patents enable people to easily use their hands to open and close doors by using gears, cams, springs and mechanical linkage to aid in door movement. However, these inventions were not useful for elderly or handicapped people that could not use their hands to open and close the doors.

Next, there were several U.S. Pat. Nos. 6,270,175 and 4,911,508 developed that did not require the use of hands to open and close doors. Nevertheless, there were still problems with these inventions because they required a user to utilize his feet to open and close the doors, which was not useful to those who could not use their feet.

Further, there was another U.S. Pat. No. 6,230,137 that was developed that did not require the use of hands or feet to open and close the door. However, this invention does not simply and efficiently open and close a door.

Therefore, there is a need for a device that enables a user to effortlessly open and close a door across a surface while expending a minimum amount of energy.

### BRIEF DESCRIPTION OF THE DRAWINGS

The novel features of the described embodiments are set forth with particularity in the appended claims. These embodiments, both as to their organization and manner of operation, together with further advantages thereof, may be best understood with reference to the following description, taken in connection with the accompanying drawings in which:

FIG. 1 illustrates an automatic door control system installed on a refrigerator in accordance with an embodiment of the invention;

FIG. 2 depicts a control schematic of the automatic door control system of FIG. 1 in accordance with an embodiment of the invention;

FIG. 3 illustrates an exploded view of a drivetrain assembly of the automatic door control system of FIG. 1 in accordance with an embodiment of the invention;

FIG. 4 illustrates an exploded view of a drivetrain assembly with a drivetrain housing removed.

FIG. 5 illustrates a drivetrain assembly being attached to a refrigerator door in accordance with an embodiment of the invention;

FIG. 6 illustrates the underside of a refrigerator having a drivetrain assembly attached thereto;

FIG. 7 illustrates a control module assembly being located on a refrigerator; and

FIG. 8 illustrates a simplified flow diagram for a method of opening and closing a door in accordance with an embodiment of the present invention.

### DETAILED DESCRIPTION OF THE PREFERRED EMBODIMENT(S)

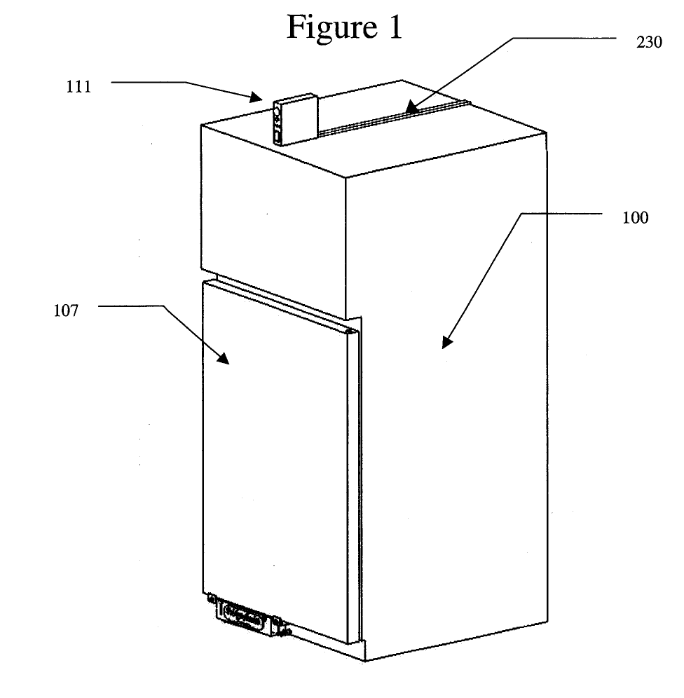

FIG. 1 displays a typical refrigerator 100 that has been equipped with an automatic door control system. Control module assembly 111 rests on top of refrigerator 100 and controls the system. It is directly connected to drivetrain assembly 109 via drivetrain cable 230, which runs behind and underneath refrigerator 100. Upon activation, drivetrain assembly 109 interacts with the floor and is designed to pull refrigerator door 107 open or pull it closed. Alternatively these elements could be integrated into the refrigerator and for all practical purposes be considered subassemblies of a single refrigerator possessing automatic door control features.

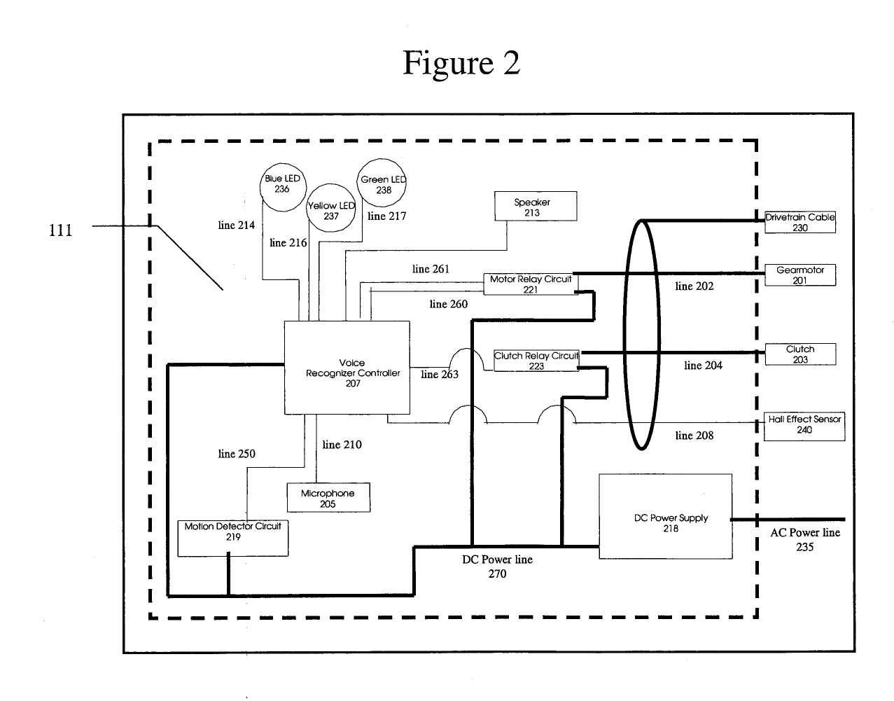

FIG. 2 is a control schematic of the automatic refrigerator door control system. A typical voice recognizer controller 207 controls the system. Such controllers possess a processor and can be configured to programmatically respond to preset voice commands as well as be interoperative with a variety of input and out devices. Accordingly, the processor of voice recognizer 207 may include a stored voice database or sound databases and preset commands database. The data in these databases may be in the form of waveforms (analog or digital). When the processor receives a command or waveform it analyzes and compares the command with the stored voice and preset commands databases. The processor determines if there is a match between the received command and a voice in the stored voice database and the preset commands database. If the combined waveform of the voice in the stored database and the preset commands database does not match the waveform of the spoken command, then the process ends. However, if the waveform of the spoken command matches with the combined waveform of the voice in the stored voice database and the preset commands database, then the voice recognizer transfers a signal to a control module (if present) or directly to a motor relay circuit 221 and/or a clutch relay circuit 223. Controllers such as this are commonplace within the industry and are familiar to those of ordinary skill in the art.

Motion detector circuit 219 comprises a passive I/R motion detector that uses a PIR sensor and is configured to send a signal on line 250 to an input of voice recognizer controller 207 once it has been triggered. Its detection range is about 20 feet. Detectors such as this are commonplace within industry and are familiar to those of ordinary skill in the art.

Microphone 205 is an omni-directional electric condenser type microphone that operates on a frequency range of 20 Hz to 16 KHz. It transmits sound signals on line 210 to a microphone input on voice recognizer controller 207. Microphones such as this are commonplace within industry and are familiar to those of ordinary skill in the art.

Motor relay circuit 221 utilizes a DPDT relay to transmit power from DC power line 270 to line 202, which conveys power to gearmotor 201 via drivetrain cable 230. It is activated by outputs from voice recognizer controller 207 on either line 260 or 261. Each line corresponds to opposing current polarities created by motor relay circuit 221, which can either energize gearmotor 201, to run clockwise or counter-clockwise. Relay circuits such as this are commonplace within industry and are familiar to those of ordinary skill in the art.

Clutch relay circuit 223 utilizes a SPST relay to transmit power from DC power line 270 to line 204, which conveys power to cable 230. It is activated by an output from voice recognizer controller 207 on line 263.

DC power supply 218 is a typical internal power supply that converts 120 VAC to 24 VDC. It has sufficient amperage to provide power to gearmotor 201, clutch 203, voice recognizer 207 and other components via DC power line 270. It receives AC power via AC power line 235.

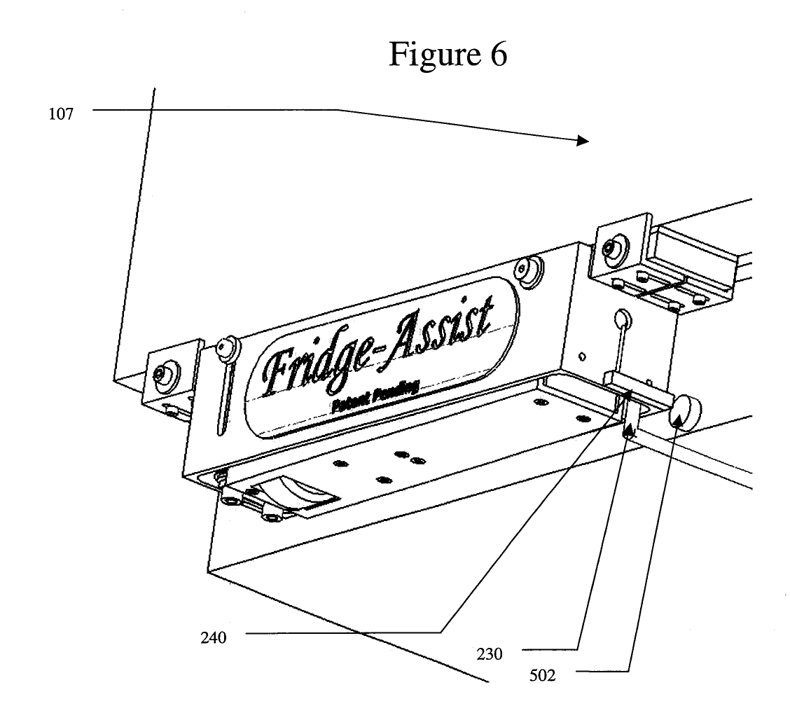

Hall effect sensor 240, which operates as a feedback device, has a switching speed of 10 KHz and is rated for 24 VDC. Once triggered by sensor magnet 502 (see FIG. 6), it will send a signal to voice recognizer controller 207 via line 208 alerting it of the positional state of refrigerator door 107. For example, the signal sent over line 208 may indicate that refrigerator door 107 is in the closed position. Alternatively, the feedback device may be implemented as a transducer or an electronic switch without departing from the scope of the present invention.

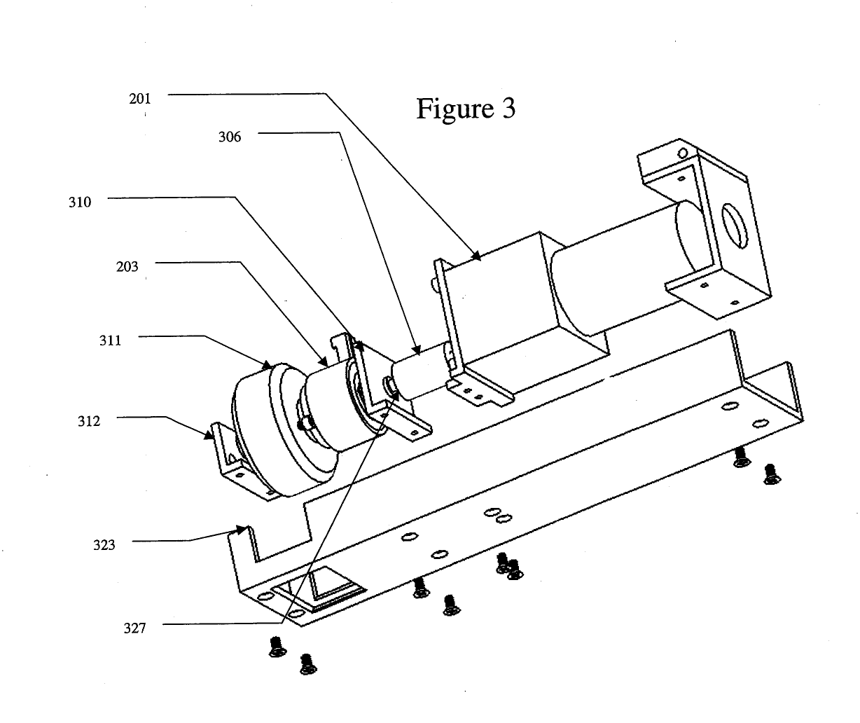

FIG. 3 is an exploded view of the powertrain of drivetrain 109 (FIG. 1). The output shaft of gearmotor 201 is attached to shaft 327 via typical shaft coupling 306. Shaft 327 is supported on each end by mounts 310 and 312, and passes through the center of clutch 203 and wheel 311. Additionally, shaft 327 is attached to the input of clutch 203 with a typical setscrew. Wheel 311 has an integral bushing that allows it to slip-fit on shaft 327. Clutch 203 may be an electromagnetic clutch and has an output with a three-dog hub which mates with three equally spaced screw heads attached to the juxtaposed side of wheel 311. Chassis 323 supports this assembly. Upon activation, clutch 203 engages, and gearmotor 201 transmits torque to wheel 311 via this assembly. While deactivated, clutch 203 will allow wheel 311 to spin freely. The free spinning option of wheel 311 would be recommended for a user to open refrigerator door 107 manually.

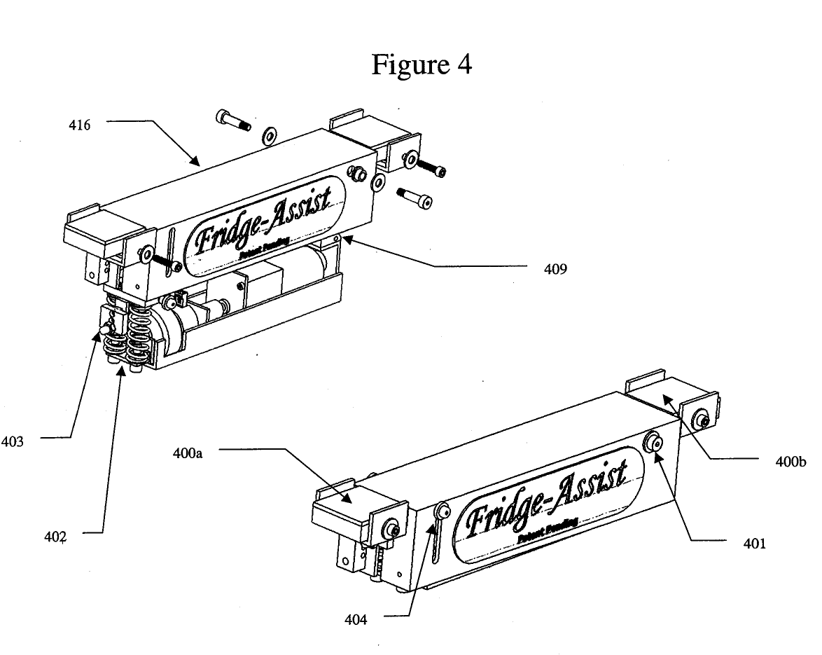

FIG. 4 displays an exploded view of drivetrain assembly 109 with drivetrain housing 416 removed. Drivetrain housing 416 is a rigid structure made of aluminum (or some other rigid material) and is pivotally attached to the rest of the assembly at the pivot mount 409 with pivot screws 401. As the door is being opened, the pivot allows wheel 311 to stay in contact with the floor as the distance between the bottom of refrigerator door 107 and the floor changes due to unevenness. To increase traction, a force producing device (i.e., a spring assembly) 402 is preloaded by compressing the springs with spring preload handle 403. Tightening preload screws 404 then retains the preload. Drivetrain assembly 109 is attached to refrigerator door 107 via integrated clamps with magnets 400a and 400b. Alternatively, the force producing device may be solenoid as opposed to a spring assembly.

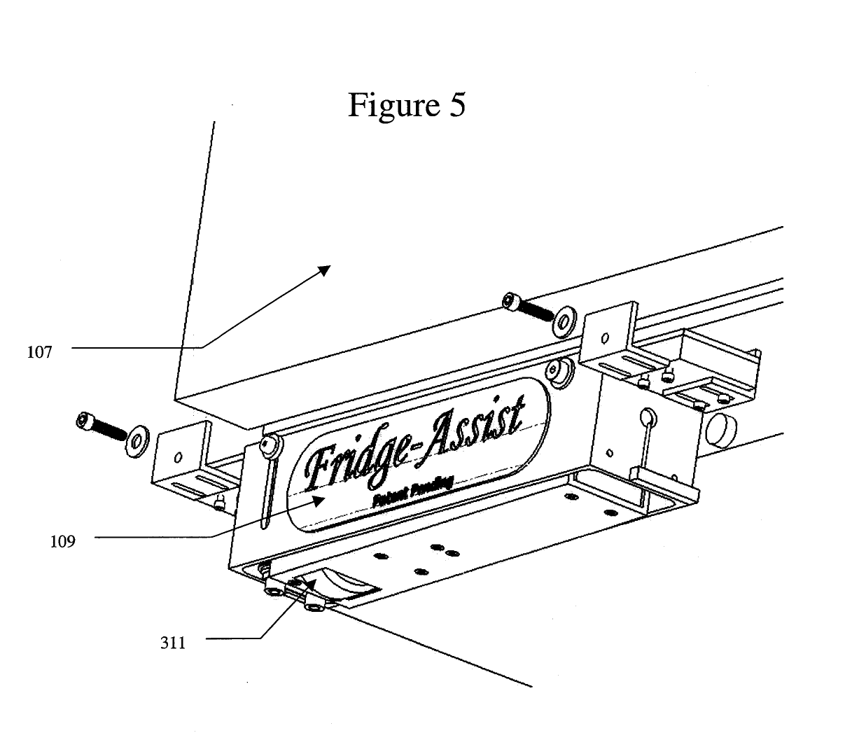

FIG. 5 displays the underside of refrigerator 100 and how drivetrain assembly 109 is attached to refrigerator door 107 via integrated clamps with magnets 400a and 400b.

FIG. 6 shows the underside of refrigerator 100 with attached drivetrain assembly 109. It also shows how hall effect sensor 204 interacts with sensor magnet 502, which is strategically positioned in close proximity to hall effect sensor 240. Additionally, drivetrain cable 230 is shown running from underneath refrigerator 100 and attached to drivetrain assembly 109.

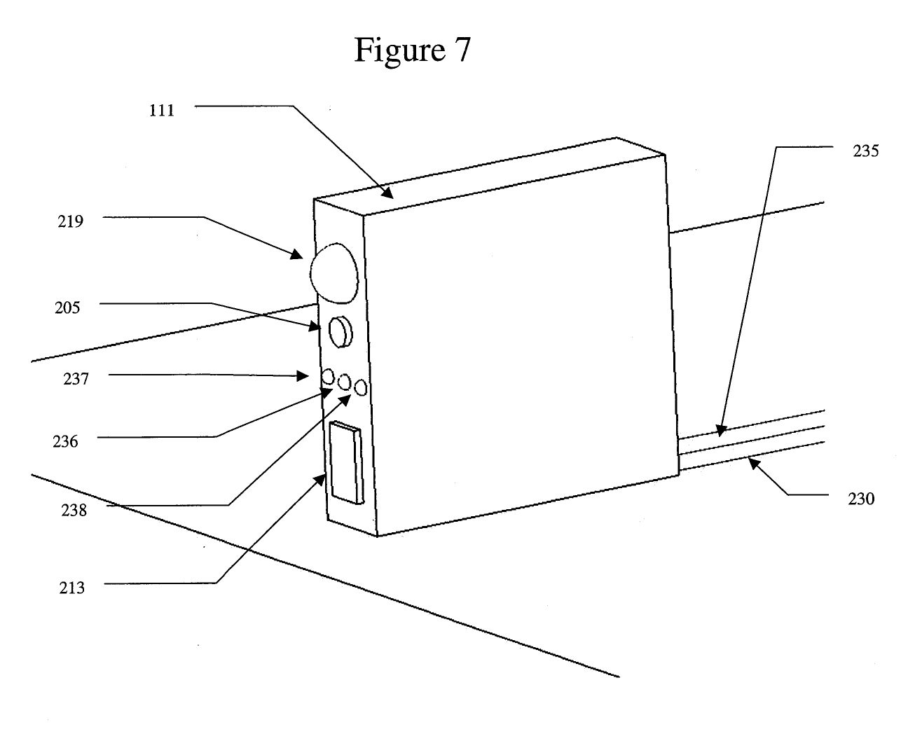

FIG. 7 shows control module assembly 111 resting atop refrigerator 100. Previously described outwardly visible features include LED's 237, 236, and 238; microphone 205, motion detector 219, speaker 213, AC power line 235 and drivetrain cable 230.

### Process Description

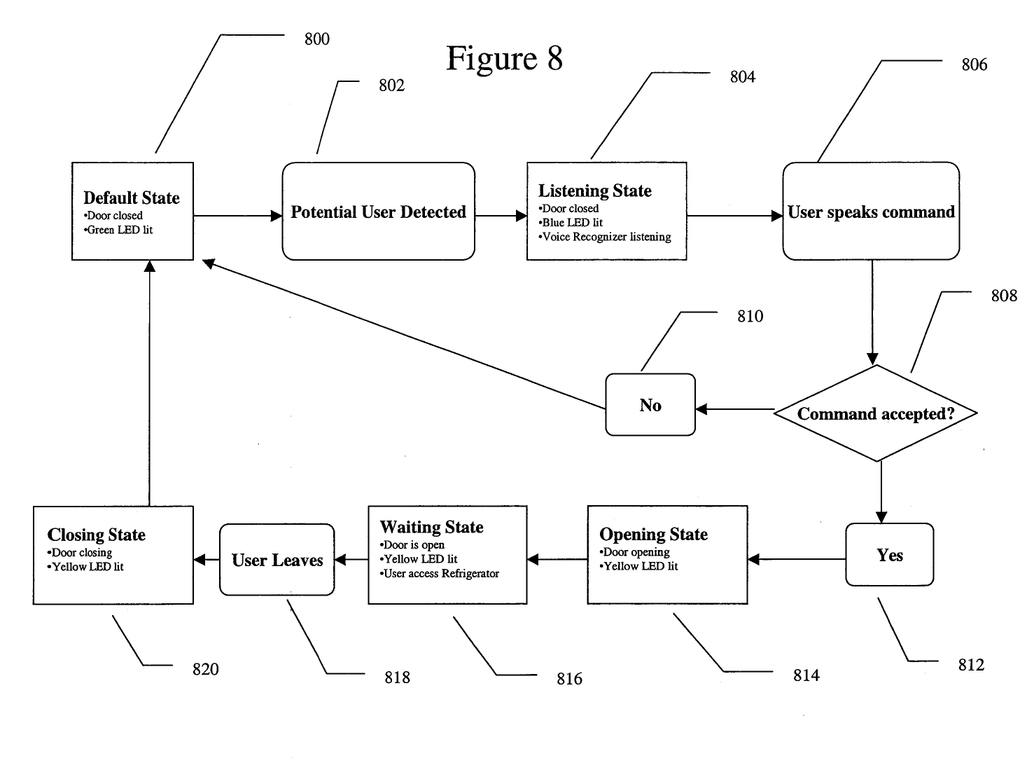

In one embodiment, there may be five distinct operating states for the automatic door control system. These states include, but are not limited to, a Default state, a Listening state, an Opening state, a Waiting state, and a closing state. Referring to FIG. 8, in the default state (Block 800), the door is in the closed position with the control module assembly displaying a green LED light 238 indicating that it is powered on. The control module assembly monitors the state of the door by receiving signals from the door positional state feedback device in the form of hall effect sensor 113 that is attached to the drivetrain assembly 115 and configured to interact with sensor magnet 502 that is strategically attached to the refrigerator.

As a potential user approaches the door (Block 802) and enters the range of the control module assembly's detection device 219, it will send a signal to voice recognizer controller 207 and the automatic door control system will enter the listening state (Block 804). Immediately, the voice recognizer controller 207 will activate blue LED indicator light 236 and begin listening via microphone 205 for a preset voice command for opening the door. Voice recognizer controller 207 will listen and wait a predetermined amount of time for the user to say the preset command (Block 806). If the user fails to speak the preset command within the allotted time (Blocks 808 and 810), the voice recognizer controller 207 will turn off the blue LED 236 and return to the automatic door control system to its default state (Block 800).

If the user does speak the open command within the predetermined amount of time (Blocks 808 and 812), the automatic door control system will enter the opening state, wherein the voice recognizer controller 207 will activate the motor relay circuit 221 and clutch relay circuit 223 (Block 814). Upon activation, these relay circuits will transmit power from DC power supply 218 to drivetrain assembly 115 via drivetrain cable 230 for a preprogrammed amount of time.

Activation of drivetrain assembly 115 causes gearmotor 201 to energize and clutch 203 to engage, driving wheel 311 to spin, pulling the refrigerator door 107 open. As refrigerator door 107 moves from the closed position, hall effect sensor 240 will signal voice recognizer controller 207 that refrigerator door 107 is open. At this point, the blue LED 236 will turn off and yellow LED 237—indicating that the door is open—will turn on.

At the conclusion of a preprogrammed amount of time, control module assembly 111 will switch off power to drivetrain assembly 115 and refrigerator door 107 will come to a stop in a wide-open position. The automatic door control system will then enter the waiting state (Block 816). During the waiting state the user is free to access the refrigerator for as long as the user wishes. If a preprogrammed amount of time elapses without any detection of the presence of a user (Block 818), the automatic door control system will enter the closing state (Block 820), wherein control module assembly 111 will activate drivetrain assembly 115 to operate in a reverse manner by relaying current with a reversed polarity to gearmotor 201 of drivetrain assembly 115, causing the refrigerator door 107 to move towards the closed position. Once refrigerator door 107 reaches the closed position, hall effect sensor 240 will transmit a signal to voice recognizer controller 207 indicating that the door is in the closed position. The control module assembly 111 will then deactivate the drivetrain assembly 115, turn off the yellow led 237 and the automatic door control system will return to its default state.

If the user approaches the refrigerator and chooses to open refrigerator door 107 by hand, the automatic door control system will not activate drivetrain assembly 115 and will immediately skip to the waiting state (Block 816). Again, if the user leaves refrigerator door 107 open for a preprogrammed amount of time, and if motion detector 219 does not detect the presence of a user, control module assembly 111 will activate the drivetrain assembly 115 to close refrigerator door 107 and the automatic door control system will return to its default state (Block 800).

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An automatic door control system that is operable with a door, the system comprising:
a control module assembly having:
a microphone for receiving a voice command;
a voice recognizer that includes a processor for storing a plurality of waveforms in a voice database and a preset commands database, the voice recognizer comparing the voice command with the voice database and the preset commands database, determining whether the voice command matches the waveforms in the voice database and the present commands database, and generating a signal that corresponds to the voice command if the voice command matches the waveforms stored in the voice database and present commands database; and
a drivetrain assembly coupled to the control module assembly and the door, wherein the drivetrain assembly is configured to receive the signal from the control module assembly to move the door, wherein the drivetrain assembly is configured to open and close the door.

2. The automatic door control system of claim 1, wherein the drivetrain assembly uses the force required to move the door with a coefficient of friction between a wheel of the drivetrain assembly and a surface that the door interacts with to move the door.

3. The automatic door control system of claim 1, further comprising a motion detector being configured to detect an object within a predetermined range of the motion detector and transmit a signal to the voice recognizer indicating that the object has been detected.

4. The automatic door control system of claim 3, wherein the predetermined range includes a range of about 20 feet.

5. The automatic door control system of claim 1, further comprising a feedback device configured to transmit signals to the voice recognizer, wherein the signals indicate a positional state of the door.

6. The automatic door control system of claim 5, wherein the feedback device includes at least one of a hall effect sensor, transducer, and a switch.

7. The automatic door control system of claim 1, further comprising a force-producing device configured to create a normal force between a wheel of the drivetrain assembly and a surface beneath the door.

8. The automatic door control system of claim 7, wherein the force-producing device creates the normal force by converting magnetic energy or electro-magnetic energy to mechanical energy.

9. The automatic door control system of claim 8, wherein the force-producing device includes a solenoid.

10. The automatic door control system of claim 1, wherein the drivetrain assembly includes:
a motor that generates torque when the control module assembly generates the signal;
a clutch that is connected to the motor through the use of a shaft and is adapted to transmit the torque;
a wheel that receives the torque; and
a spring for exerting a normal force on the wheel to force the wheel to contact a surface beneath the door to open and close the door.

11. A method of operation for an automatic door control system, the method comprising:
sending a command to the automatic door control system;
analyzing and comparing the command with databases at the automatic door control system;
determining if the command can be performed based on a positional status of a door, if there is a match between the command and the databases;
activating a drivetrain assembly of the automatic door control system based on the command, if the positional status of the door is such that the command can be performed, wherein the drivetrain assembly applies a force to a wheel mounted on the drivetrain assembly to move the door.

12. The method of claim 11, wherein the databases comprise sound databases and preset commands databases.

13. The method of claim 11, wherein the command is a waveform.

14. An automatic door control system that is operable with a door, the system comprising:
a control module assembly having:
a microphone for receiving a voice command;
a voice recognizer that includes a processor for storing a plurality of waveforms in a voice database and a preset commands database, the voice recognizer comparing the voice command with the voice database and the preset commands database, determining whether the voice command matches the waveforms in the voice database and the present commands database, and generating a signal that corresponds to the voice command if the voice command matches the waveforms stored in the voice database and present commands database;
a drivetrain assembly coupled to the control module assembly and the door, wherein the drivetrain assembly is configured to receive the signal from the control module assembly to move the door, wherein the drivetrain assembly is configured to open and close the door;
a motion detector being configured to detect an object within a predetermined range of the motion detector and transmit a signal to the voice recognizer indicating that the object has been detected; and
a feedback device configured to transmit to the voice recognizer signals that indicate a positional state of the door.

15. The automatic door control system of claim 14, further comprising:
further comprising a force-producing device configured to create a normal force between a wheel of the drivetrain assembly and a surface beneath the door.
